(19) United States
(12) Patent Application Publication
(10) Pub. No.: US 2004/0010437 A1
(43) Pub. Date: Jan. 15, 2004

(54) Method and system for scheduling and sharing a pool of resources across multiple distributed forecasted workloads

(76) Inventors: Ali Sukru Kiran, San Diego, CA (US); Jeffrey C. Cameron, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/610,780

(22) Filed: Jun. 30, 2003

Related U.S. Application Data
(60) Provisional application No. 60/392,693, filed on Jun. 29, 2002.

(51) Int. Cl. G06F 17/60

(52) U.S. Cl. 705/8

(57) ABSTRACT

A method for scheduling resources from a workforce pool, including the steps of updating human resource information regarding availability of each human resource, forecasting human resource workload for a specified time period, storing the human resource information and the forecasted human resource workload information into a central database, accessing the central database to schedule non-pooled human resources, determining understaffed time periods by comparing the forecasted human resource workload versus available resources from scheduling the non-pooled human resources and scheduling pooled human resources to cover the understaffed forecast. Also disclosed is a system for scheduling a pool of human resources, including a system for scheduling a pool of human resources, a central database for storing human resource information, including human resource availability and current scheduling information, the database being electronically connected to a network, at least one remote work station connected to the database via the network, wherein the remote work station allows the viewing of forecasted workloads, and current staffing assigned to the forecasted workloads to determine periods of understaffing and overstaffing.

### RELATED APPLICATIONS

This application claims the benefit of U.S. Application Serial No. 60/392,693 filed on Jun. 29, 2002, which is hereby fully incorporated by reference herein as though set forth in full.

### FIELD OF THE DISCLOSURE

The present disclosure relates to a method and system of scheduling a workforce utilizing pooled staffing by sharing resources across multiple locations based on forecasted workforce demand and resource availability.

### BACKGROUND OF THE DISCLOSURE

Workforce scheduling includes a problem of assigning resources to each planned time period for an organization. Organizations have attempted to use a wide range of forecasting techniques to predict the number of human resources required for staffing purposes and to assist in the scheduling of the human resources for the planned time periods. Computer-based systems have improved customer service as well as reduced costs for human resource planning, particularly in the service industry. Other computer systems have helped with workforce planning, however, there are inefficiencies in the computer systems due to real world constraints, such as large swings in human resource demands and resource availability to meet the demands. Organizations have built systems and processes to reduce the inefficiencies in existing computer-based scheduling systems, and one example is the formation of resource pooling, which allows the scheduling of human resources across multiple departments or organizational locations.

Human resource or workforce pools solve many of the real world problems, such as large swings in workforce demands, hiring costs, and resource availability. For example, a common real world constraint is the minimum and maximum hours a resource is available to work in a particular week. When the maximum hours of all the resources are exceeded, but demand is still not satisfied for the organization, a new resource must be hired. Hiring this resource to meet workforce demand in one period causes overstaffing in other periods because this resource has to work a minimum number of hours.

Large swings in resource demands also generate large inefficiencies due to the need to hire additional resources to cover the heaviest demand in terms of time periods, which leads to overstaffing during slower time periods. Workforce pooling provides access to resources during heavy work time periods, eliminating the need to hire new resources to meet peak demand.

Resource availability is another major source of inefficiency in an organization which is solved by resource pooling. Resources may be unavailable during peak times, which drive the need to have additional resources on staff to cover peak time periods. When all resources are available, overstaffing may occur because, typically, each resource has to be scheduled for a minimum number of hours.

Workforce pools have several advantages and solve many of today's real world scheduling inefficiencies; however, due to the lack of computer-based systems and tools to effectively manage resource pools, many of the benefits are never realized. In the majority of situations, resource pools are managed centrally by the workforce scheduler calling into a central location. The central location manages the resource pool by scheduling resources based on need, availability and geographic location. Nevertheless, resource pooling management by a central location is costly and difficult to manage, which minimizes the benefit of having pooled resources.

Therefore, there is a need for a more efficient system and method for scheduling and sharing a pool of resources.

### SUMMARY OF THE DISCLOSURE

Disclosed is a method for scheduling resources from a workforce pool, including the steps of updating human resource information regarding availability of each human resource, forecasting human resource workload for a specified time period, storing the human resource information and the forecasted human resource workload information into a central database, accessing the central database to schedule non-pooled human resources, determining understaffed time periods by comparing the forecasted human resource workload versus scheduled resources from the non-pooled human resources, and scheduling pooled human resources to cover the understaffed forecasted workload.

Also disclosed is a system for scheduling a pool of human resources, including a system for scheduling a pool of human resources, a central database for storing human resource information, including human resource availability and current scheduling information, the database being electronically connected to a network, at least one remote work station connected to the database by the network, wherein the remote work station allows the viewing of forecasted workloads, and current staffing assigned to the forecasted workloads to determine an understaffing, overstaffing, or properly staffed situation.

The disclosed method and system provide means for scheduling a pool of human resources based on forecasted workloads. The disclosed method and system also may be utilized to schedule human resources based on the skill set ratings of each particular human resource, as well as based on human resource availability and geographic location to the workload center.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 illustrates a user interface according to the present disclosure for scheduling pooled resources for a forecasted time period;

FIG. 2 illustrates a user interface utilized by a scheduler for viewing scheduled resources;

FIG. 3 is a user interface utilized by a scheduler for scheduling a resource for a specific time period;

FIG. 4 is a schematic for sharing resources across workload centers;

FIG. 5 is a schematic used for central resource pool scheduling;

FIG. 6 is a schematic for geographic resource pool scheduling;

FIG. 7 is a schematic for virtual work force pool scheduling;

FIG. 8 illustrates a schematic representation of the system according to the present disclosure; and

FIG. 9 illustrates the process of scheduling pooled resources according to the present disclosure.

### DETAILED DESCRIPTION OF THE PREFERRED EMBODIMENTS

The system and method disclosed herein disclose a work force scheduling and a resource pooling feature that enables managers on a day to day basis to effectively share resources, or human resources, across multiple locations from their desk, such as from a desktop computer or other electronic device. The pooling feature enables managers to bypass costly and complex pools managed at a higher level, while achieving the benefits of pools, or labor pools, as explained herein.

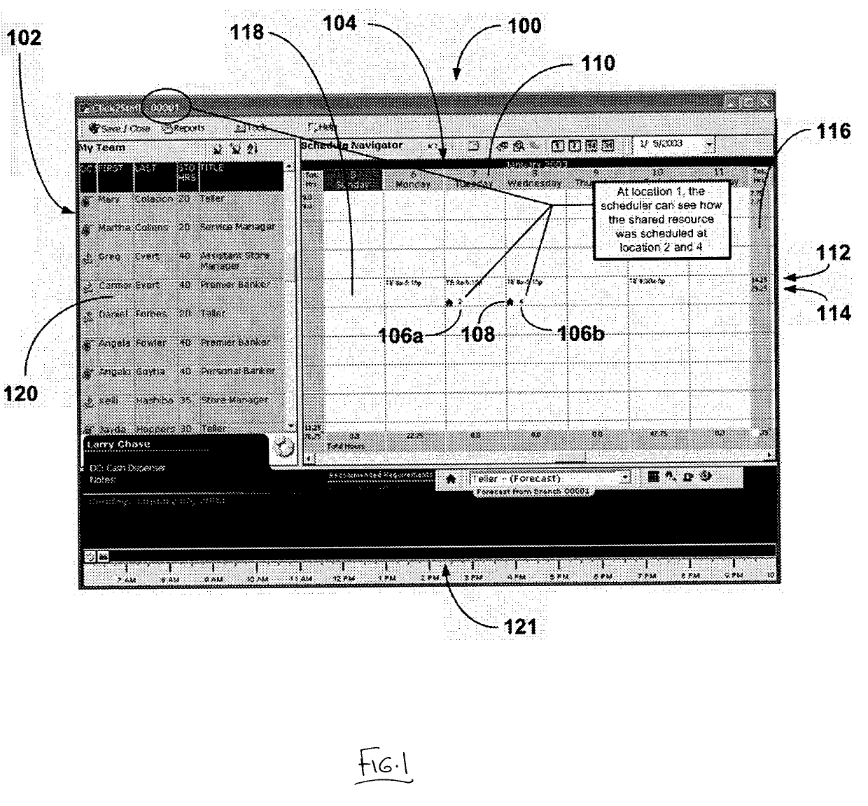

As shown in FIG. 1, the scheduler logs into the system disclosed for viewing the scheduling needs for an office. FIG. 1 illustrates a scheduling interface 100 that the scheduler views on a computer by utilizing the disclosed system and method. The schedule will show a list of resources 102 and their corresponding schedules. If a resource works at multiple locations, then the user interface reflects the resource's schedule at all locations from a single scheduling window 104. This is depicted by showing the location number 106 next to a location icon 108 in the schedule window corresponding to the day 110 and the resource scheduled. The total hours for a resource are rolled up at the end of every week and separated out into paid hours at the current location, as shown at the top 112, and paid hours at all locations, as shown at the bottom 114. This is depicted in the gray statistics bar 116 between each week. Therefore, the scheduler at location 1 would open the scheduling interface 100 at a remote computer located at location 1. Next, the human resources 102 assigned to location 1 would be shown on the left hand side of the user interface 100, as shown by resources 102. In addition, the resources that have already been scheduled will appear in a corresponding row 118 that corresponds with each particular resource located on the left hand side of the scheduling interface 100. For example, Carmen Everett 120, as shown in FIG. 1, is scheduled to work on Tuesday, January 7th from 9:00 am to 5:15 pm at location number 2. Therefore, since Carmen Everett is being viewed from the user interface at location number 1, and the resource is shown scheduled for branch number 2 on Tuesday, January 7th, and shown scheduled to work at location number 4 on Wednesday, January 8th, resource 120 is a shared resource between locations. If the scheduler would like to schedule a resource 102 to a day to work, the scheduler selects a cell by clicking on the cell next to the desired resource 102 under the correct day heading 110. Once a cell is selected the scheduler then clicks and drags across the time span 121 to create a scheduled shift corresponding to the time span.

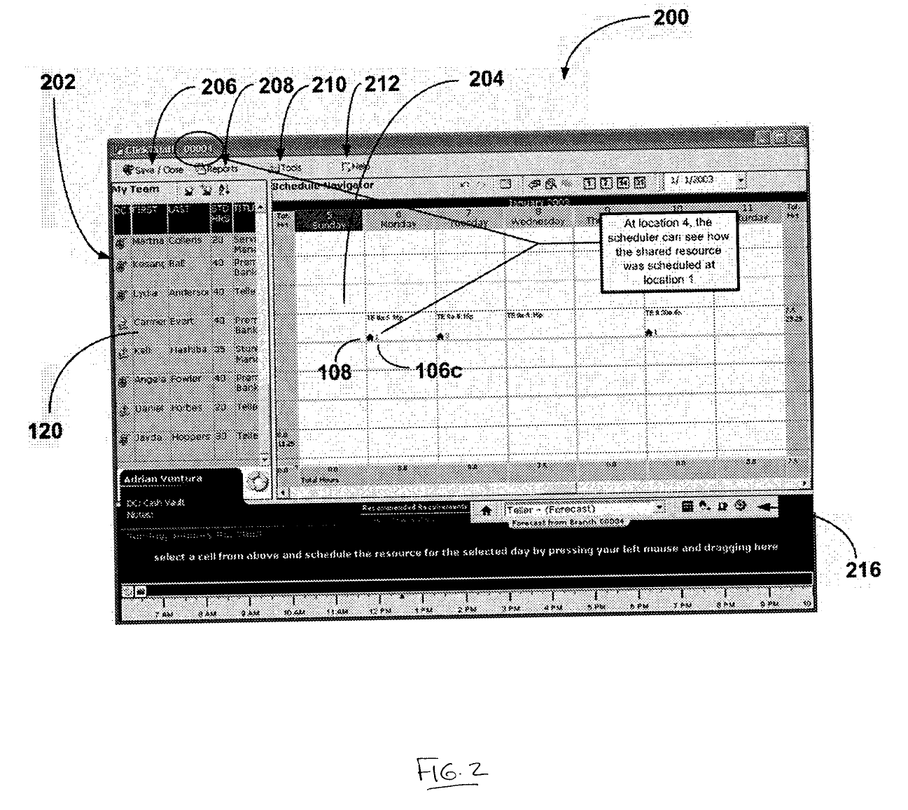

FIG. 2 illustrates the scheduling interface 200 as utilized, in this example, at location number 4. The scheduler opens the scheduling interface 200, a different set of resources 202 are shown at the left hand side of the scheduling interface 200. The scheduling interface 200 is similar in configuration to the scheduling interface 100, as shown at location number 1, except that scheduling interface 200 illustrates to the scheduler the resources 202 that are available at location number 4, as well as illustrates the scheduled times for each resource 202, as shown in row 204 by way of example. The scheduling interface 200 further illustrates to the scheduler at location number 4 those resources that are shared between locations. For example, in referring to resource 120 and FIG. 1, the same resource 120 is shown to be scheduled on Monday, January 6th at location number 1 as shown by branch icon 108 and branch number 106c. The scheduling interface, no matter from which location viewed, includes several tool bars and icons to assist the scheduler in utilizing the scheduling interface. For example, any scheduling information completed through the scheduling interface may be saved and closed by utilizing the save icon 206. Further, the reports icon 208 makes available and produces a number of reports available to the user. For example, these reports may include the daily schedule, weekly schedule, monthly schedule, and scheduled vs. forecasted workload plot. Further, yet, the tools icon 210 provide access to user defined interface preferences and access to additional add-ins. In addition, a help icon 212 provides access to help files to answer the user's questions regarding the scheduling interface.

The scheduling interface further includes a tool bar 216 that provides the scheduler additional features related to scheduling such as applying automatic break logic, finding resources to work a shift, locking the position, and hiding the breaks. The drop down list on the toolbar allows the scheduler to switch between different workload forecasts. In FIG. 2, the forecasted workload being shown is for the skillset or position of Teller.

The user or scheduler schedules a resource for a shift by first selecting a resource and day to schedule. To select a resource and day the scheduler clicks in the cell next to the resource 120 under the correct day heading 316. Once the user has selected the cell 318 the workload corresponding the skillset or position in the drop down 320 is displayed above the time axis 322 at the bottom of the scheduling window. The forecasted workload is a depicted as a small bar running the length of the scheduling screen 314 with a series of positive red and negative green numbers aligned with the time intervals in the time axis. The red positive numbers denotes the number of resources the scheduler has overstaffed during a time period and negative green denotes a number of resource the scheduler has understaffed during a time period. Once the scheduler has determined from the workload what time to schedule the selected resource for the day the scheduler clicks and drags along the time axis the corresponding time period. Next, a pop-up 302 appears for resource 120. The pop-302 includes the locations that resource 120 is available to work at, as shown in drop down 304. In addition, classifications for the type of work or time off is provided in window 306. The scheduler then selects the location from window 304, and the type of work or time off from window 306. The selected location will be displayed in the window 308 and the selected type of work will be highlighted. Next, the scheduler either selects the okay icon 310 or the cancel icon 312. If the cancel button is selected the operation is canceled and if the okay button is selected the type of work is scheduled for the corresponding period. The workload bar 314 is updated accordingly based on the type of work scheduled.

When a user schedules a resource for a shift, the system of the present disclosure will request from a server all of the locations that the resource is assigned to, or is available to work from, this will be explained in further detail below. The system will also request permission of the scheduler utilizing the scheduling interface to determine the locations that the scheduler is authorized to scheduled resources too. For example, the scheduler may have the authorization to schedule resources at multiple locations. If the scheduler can actively schedule resources at the locations requested, then the scheduler from one location may schedule a resource at another location. When the scheduler schedules resources in this fashion, the electronic schedule displayed in the scheduling interface of the other location will reflect the scheduling and changes, if any, as scheduled by the scheduler from the other branch location.

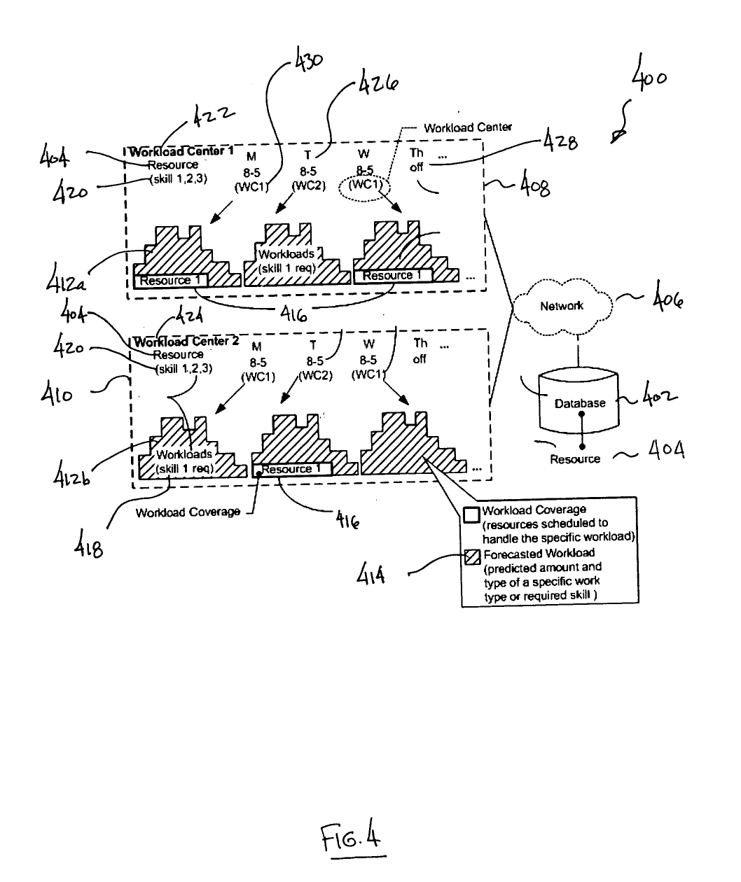

In another embodiment, shown in FIG. 4, a schematic representation is made for scheduling and sharing pooled resources across workload centers, according to the system and method disclosed herein. FIG. 4 illustrates the system for illustrating how resources are shared across multiple distributed workload locations, such as branch locations, call centers, etc. The system disclosed herein allows the scheduler at the workload center to schedule a resource based on availability, skill set, and workload need of the workload center. In the example shown in FIG. 4, the system 400 includes a database 402 which stores information about a resource 404. The database 402 is connected to a network 406. Connected remotely to the network 406 are remote work stations that are illustrated in the schematic of FIG. 4 as remote work station 408 at workload center 1 and remote work station 410 at workload center 2. Remote work stations 408 and 410 each illustrate the workload demand for the week as illustrated by bar graphs 412a and b. Bar graphs 412 illustrate the week displayed on each remote work station. The bar graph includes indicia, as such as hatch marks 414 illustrating the forecasted workload for each workload center for each day displayed and the schedule coverage of the workload. The forecasted workload is computed by using historical data from each workload center to forecast the future workload by day by 30 minute time interval. The workload coverage is computed by the number of resources scheduled during any time interval. The difference between the workload coverage and the forecasted workload is the number of resources overstaffed or understaffed at any time interval. If the scheduler has more coverage than workload there is an overstaffing scenario and vice versus.

The bar graph 412 represents a workload for a required skill set as shown in the example as skill 1 required 418. In the example shown, resource 404 has a skill level ranking of 1, 2, and 3 as shown in legend 420, therefore can be scheduled to the workload requiring skill 1. The remote work stations 408 and 410 further include a legend 426 identifying which workload center is being displayed, such as workload center (1) 422 or workload center (2) 424. Remote work stations 408 and 410 further include a legend 426 illustrating the day of the week as well as the hours that resource 404 is available to work. The legend 426 also illustrates any day off that resource 404 is authorized or has requested to take off, as shown in 428. The remote work stations 408 and 410 further display the workload centers that resource 404 is scheduled to work at, as shown by 430.

In the example show in FIG. 4, resource 404 is scheduled to work at workload center (1) as shown by WC1 on Monday, workload center (2) on Tuesday, as illustrated by the WC2, and then at workload center (1) as shown by WC1 on Wednesday. Further, resource 404 is scheduled to be off of work on Thursday. Therefore, as shown in the example in FIG. 4, the schedule for resource 404 may be viewed for a particular time period, even if the resource 404 is scheduled to work at different workload centers. The system and method as disclosed herein, allows the scheduler to visualize the schedule for a resource 404, even if the resource is scheduled to work at multiple workload centers. The system disclosed herein by utilizing the scheduling interface allows the schedule for a single resource to be visible to the scheduler at each workload center where a resource is scheduled to work. The system disclosed herein provides the synchronization of the resources scheduled, which prevents a single resource from being scheduled at multiple workload centers at the same time and date. The synchronization and display of the schedules, resources, workloads, and availability of multiple resources and workload centers is handled by the system disclosed herein by utilizing the scheduling interface and the central data base 402.

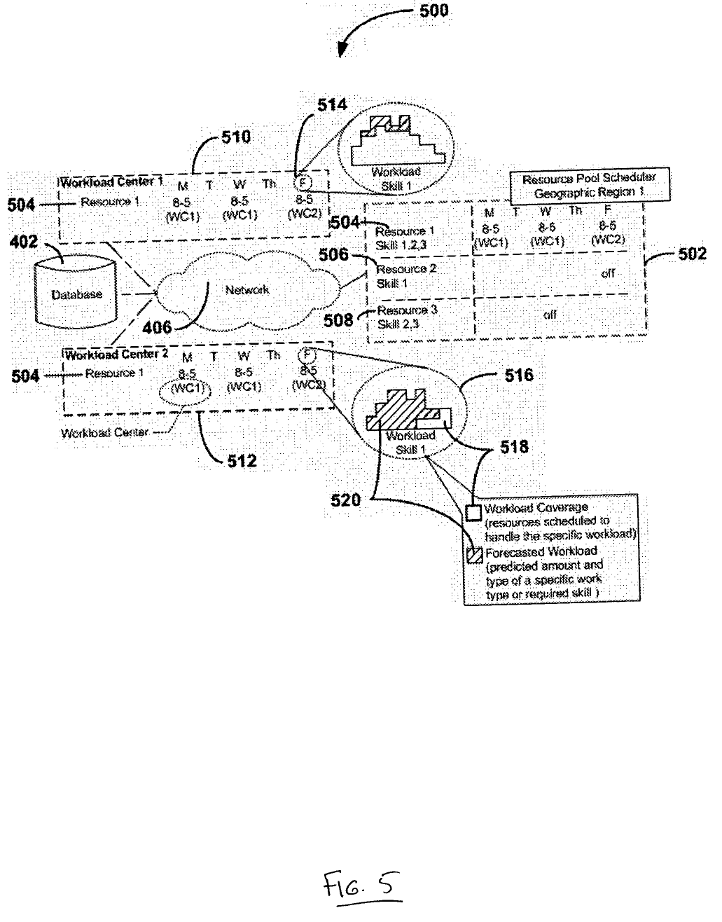

FIG. 5 illustrates and alternative embodiment of the system and method disclosed herein. FIG. 5 illustrates a schematic of the system 500 which allows a central scheduler to schedule pooled resources to multiple workload centers based on availability, skill set, and forecasted workload for the workload center. The schematic illustrates database 402 connected to network 406. Database 402 contains information regarding each resource that is available to be scheduled to work based on availability, skill set, and geographic location. The resource pool is geographically based so that the central scheduler may schedule workers who are in close proximity or driving distance to the workload center to be scheduled. For example, interface 502 illustrates resources 504, 506 and 508 with resource 504 having skills 1, 2 and 3 as indicated in window 502. Further, resource 506 can only perform skill 3, and resource 508 is able to do skills 2 and 3. Further, window 502 illustrates the work schedule for each resource, for example, resource 504 is scheduled to work Monday, Wednesday and Friday from 8-5, with resource 504 working at work center number (1) on Monday, work center number (1) on Wednesday, and work center number (2) on Friday. Further, resource 506 is scheduled to be off on Wednesday, and resource 508 is scheduled to work on Friday. Window 510 illustrates that resource 504 is scheduled to work at workload center (1), Monday and Wednesday from 8-5, and scheduled to work on Friday from 8-5 at workload center number (2). Further, as shown by window 512, workload center number (2) may also view the schedule for resource 504. The central scheduler schedules the resources to the appropriate workload center using a similar interface as shown in FIG. 1. The only functional difference is the ability to switch between the workloads and workload coverage at the different workload centers. The central scheduler may view the workload coverage for a workload center by selecting a day of the week, such as Friday 514 for a workload center (1). A workload plot window 516 is illustrated when the central scheduler selects on the day of the week 514 for a workload center. The graph shown in 516 illustrates the workload requirements at workload center (2) on that day of the week 514. The white area 518 illustrates the workload coverage. The hatched portion of the graph illustrated as 520 illustrates the uncovered workload. The central scheduler will utilize resources in the pool to cover the uncovered workload at each of the workload locations. The system 500 disclosed in FIG. 5 allows the synchronization of the displays showing the availability of resources and the workload forecasts at all of the workload centers of an institution.

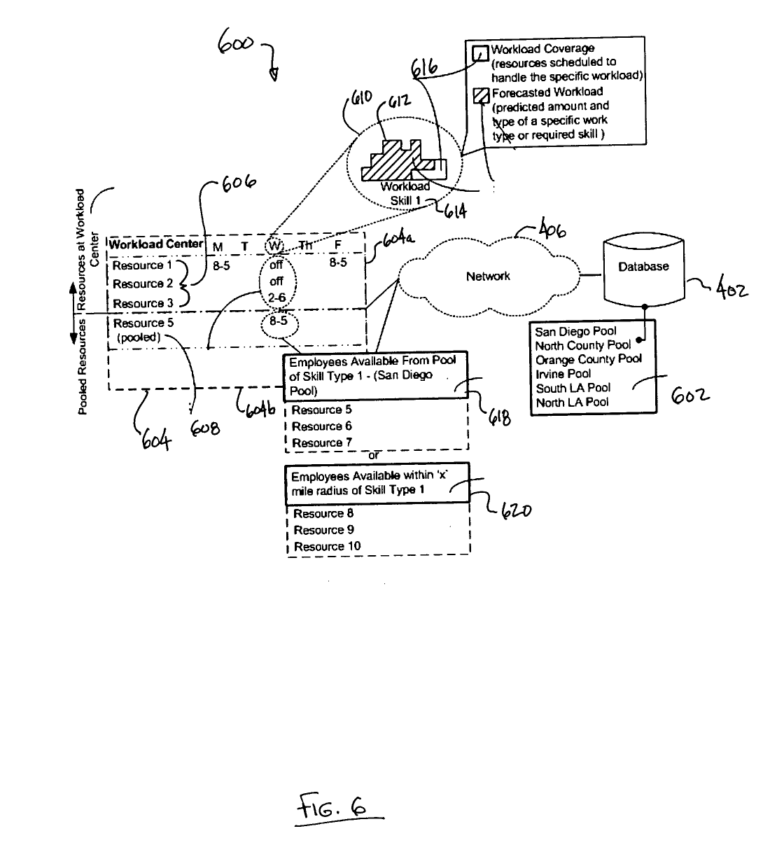

FIG. 6 illustrates an alternative system 600 according to the present disclosure, wherein the central scheduler may staff resources according geographic resource pools. As shown in FIG. 6, database 402 contains geographic electronic data 602 that are stored based on geographic parameters. The database 402 is connected to network 406, which provides access to the database 402 and the geographic electronic data 602 to a central work station utilized by a central scheduler or remote work stations utilized by remote schedulers. The schedulers utilizes a system interface that provides an open window 604. Window 604 includes the workload center information as well as resource identification, skill set, availability, and whether the resource is a pooled resource or a resource available at a workload center.

For example, in the example shown, window 604 includes resource information indicating availability at the workload center by showing resources 606. Window 604 is divided into a first window 604a that shows resources that are available at a workload center, and window 604b that shows pooled resources scheduled at the workload center. Window 604a further shows the skill set of each resource available at the workload center (skill set not shown in this example), the schedule of each resource, such as resource 1 is available on Monday from 8-5, is off on Wednesday, and is available on Friday from 8-5. Further, window 604b illustrates that resource 5 is from a pooled resource and is available on Wednesday 8-5. The scheduler can select a day of week and determine whether a particular day is properly staffed, and if not properly staffed, the scheduler may adjust or schedule the proper resources by utilizing the system 600. In the example shown, when the scheduler selects on Wednesday they can view the forecasted workload 610 for a particular skill set 614.

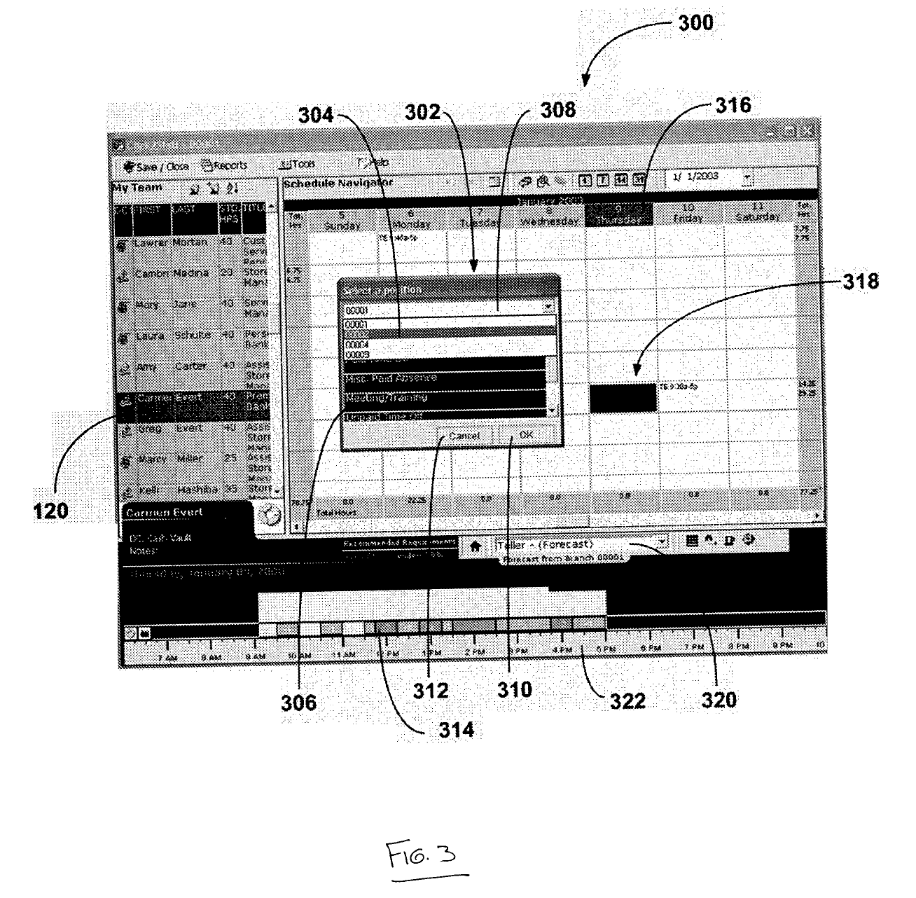

In the illustration shown, the forecasted workload 612 has not been fully scheduled with resources and area 616 of the forecasted workload illustrates the workload coverage. Further, in the example shown, the forecasted workload 612 requires the scheduler to schedule more resources to cover the forecasted workload and, therefore, the scheduler may utilize employees available from the pooled resources 608 to properly staff for the forecasted workload. Using an interface similar to the one in FIG. 1, the scheduler will schedule a shift by clicking and dragging across the time access where the workload coverage is needed. The scheduler will be presented a position or skill picker as in 302 of FIG. 3, where they would select the appropriate skill. Next, the scheduler will see a popup window 618 displaying the resources available from the pooled resources of the selected skill type 618, skill type 1 in this example. The user will select the resource from the list and the resource will be scheduled and displayed at the workload center where resource 5 608 is in this example.

In the alternative, the scheduler, after selecting the skill as in the example above, will be presented a pop-up window 620 displaying the resources available within a defined distance radius of the workload center, and can perform the selected skill type. Therefore, the system 600 disclosed in this embodiment allows a scheduler at a workload center to access and schedule a resource pool when there are no resources currently available at the current workload center that can perform the workload skill, and the current workload forecast is not fully covered.

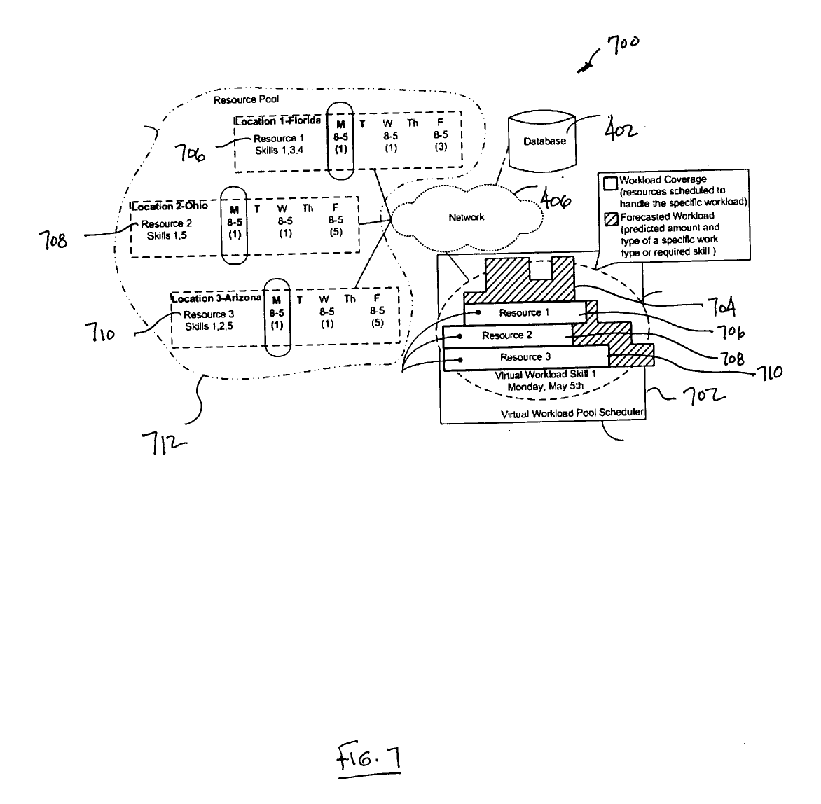

FIG. 7 illustrates yet another embodiment to schedule resources according to the present disclosure. In this embodiment, a system is disclosed for scheduling the proper skilled resources and the available resources from a geographically independent pool in order to cover a forecasted virtual workload. In this embodiment, a virtual workload is a workload that requires resources to conduct electronic work, such as electronic document processing, which requires human interaction for processing, but does not require the resource to be physically located at a workload center. Therefore, a resource can perform a virtual workload task by working remotely, even if the resources are located in different locations or even different states. In this embodiment, the virtual workload may be routed to any appropriately skilled and available resource regardless of the resource geographic location.

Referring to FIG. 7, system 700 illustrates database 402 connected to network 406. System 700 further includes a central workload scheduling interface 702, which illustrates a forecasted virtual workload 704. The scheduler may schedule resources to the forecasted workload 704, and in the example shown resources 706, 708 and 719, all with a skill set 1, are shown scheduled for Monday, May 5. The scheduler then can schedule additional resources for the forecasted workload that remains understaffed.

Via the network 406 each workload center 712 can access, view, and edit the resource information, such as resource 706, resource 708, and resource 710. The access at the workload centers is to enter in resource availability and print schedules and reports, all the scheduling is performed at the central virtual pool scheduler 702. In this example, resource 706 is from location 1 in Florida and resource 706 is available to perform skills 1, 3 and 4. Further, resource 706 is scheduled for Monday from 8-5 to perform skill 1, as shown in interface 702. Further, resource 706 is also scheduled for Wednesday from 8-5 to perform skill 1 and scheduled to work on Friday from 8-5 performing skill 3. Further, resource 708 is from location 2, which is Ohio in this example. Resource 708 is scheduled for Monday from 8-5 performing skill 1, scheduled for Wednesday from 8-5 at skill 1, and scheduled for Friday 8-5 at skill 5. Further, resource 710 is located at location 3, and in this example, location 3 is in Arizona. Resource 710 is further scheduled to work on Monday from 8-5 performing skill 1, and scheduled for Wednesday 8-5 performing skill 1, and also scheduled for Friday from 8-5 at skill 5. The central scheduling data, workload, and location data as shown in system 700 are synchronized by utilizing the scheduling interface 702 and the central database 402.

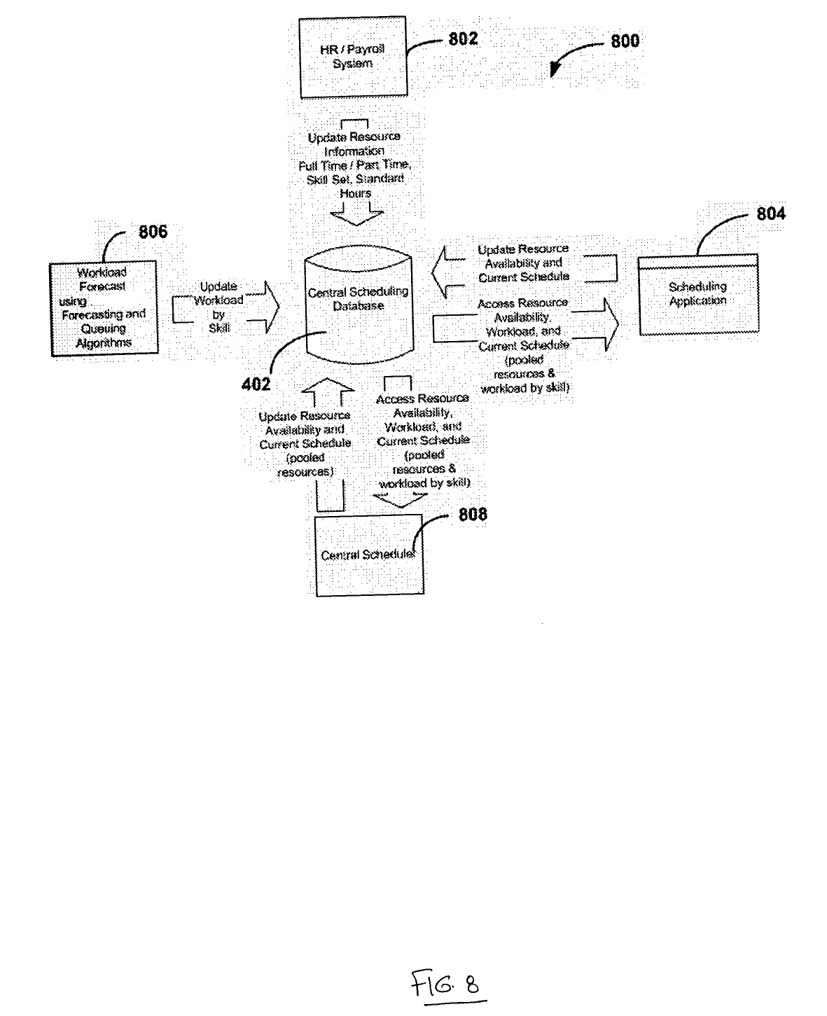

FIG. 8 illustrates a schematic representation of the system 800 and method according to the present disclosure. A human resources and payroll component 802 includes electronic files that includes resource information, such as full time or part time status, skill set, and standard hours worked. This information is stored in the central scheduling database 402. In addition, all workload location information is stored in the database 402 and is pulled down across the network and viewed or edited in the scheduling interface 804 at the time of scheduling. The workload locations data 804 include resource availability, workload, and current schedule information, all of which are stored in the central scheduling database 402.

The system 800 further includes workload forecasts 806 based on historical information. The forecast may be conducted weekly, bi-weekly, monthly, or any other time interval based on the historical data that the forecast is based upon. The workload forecasts 806 are produced for each skill set during the forecasting time period and uploaded to the central scheduling database 402 for storage. In addition, the system 800 includes a central scheduler component 808 which provides updated resource availability and current pooled resources scheduling information to the central scheduling database 402. Further, the central scheduling database 402 provides resource availability, skill set workload, and current scheduling information on pooled resources to the central scheduler 808.

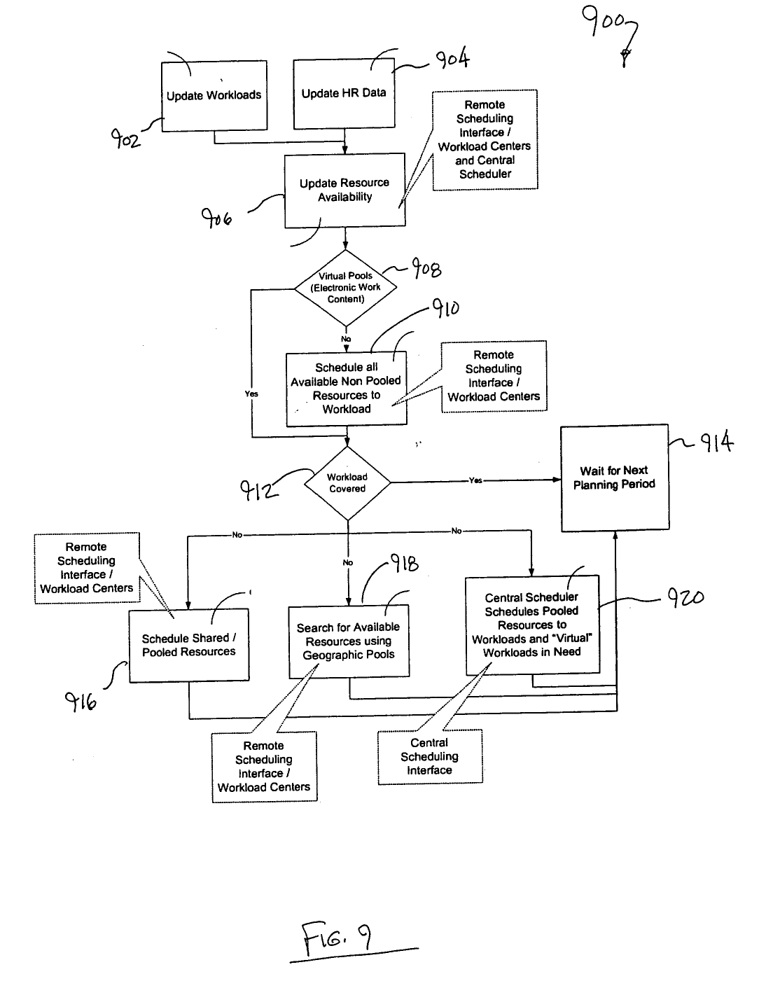

FIG. 9 illustrates a process 900 flow according to the present disclosure. Step 902 illustrates the step of updating the workloads based on forecast information. Step 904 illustrates the step of updating the human resource and payroll data information. The updated workloads from step 902 and the updated human resource and payroll data from step 904 are used to update the resource availability in step 906. The remote scheduling interface at the workload centers or the central pool scheduler as disclosed herein is used to update and edit the resource availability. Step 908 illustrates the decision of determining whether virtual work pools are utilized or not. If virtual work pools are not utilized, then at step 910 a step of scheduling all available non-pooled resources to the forecasted workload is completed. The remote scheduling interface at the workload centers as disclosed herein is used to schedule all non-pooled resources. If virtual work pools are utilized, then step 910 is skipped. The next step in the process is the decision step of 912, wherein it is determined whether the forecasted workload is covered or not. If the workload is covered, the last step is step 914 which is waiting for the next planning period. If the workload is not covered, then three options are available to the scheduler. The options include step 916 for scheduling shared or pooled resources utilizing the remote scheduling interface according to the present disclosure. In addition, another option available to the central scheduler is step 918 for searching for available resources using geographic pools, as disclosed herein. Another option available to the central scheduler is step 920 for the central scheduler to schedule pooled resources to workloads and virtual workloads in need of resources. Step 918 includes the use of the remote scheduling interface disclosed herein. Step 920 utilizes the central scheduling interface which is also disclosed herein.

In all the embodiments disclosed herein, the same scheduling system interface is utilized to handle each method of schedule resource pooling. The first step in each of the pooling scenarios is populating the human resource information and forecasted current workload. The human resource information is generally acquired from third party software, such as PeopleSoft® from Pleasanton, Calif. The forecasted workload is generated by a workload forecasting tool which is part of the scheduling system disclosed herein. Both sets of data are stored in a central database.

The next step in the process is for the schedulers at the remote locations and the central schedulers to determine and enter the resource availability into the system for the next planning time period. The resource availability is utilized during the planning period to determine which period and which workload centers need pooled resources.

Once the resource availability, the forecasted workloads, and the human resource data is loaded into the central database, the data is accessed in the initial scheduling of non-pooled resources as performed by the workload centers in all of the scenarios, except the virtual pooling scenario where this step is bypassed. This step is bypassed in the virtual pooling scenario because all resources are treated as pooled resources and all resources are scheduled centrally.

Once all the non-pooled resources are exhausted, one of the four pooling scenarios disclosed herein is utilized by either a central scheduler or workload center scheduler to cover the uncovered forecasted workload. Once all the pooled and non-pooled resources are utilized or the workload is covered for the planning period, the scheduling process stops until the next planning period is to be scheduled.

When a user schedules a shift for a resource, the application of the present invention will request from the server all the locations that the resource belongs to, or is available to work from. The application will also request the permissions of the current user to actively schedule resources at specific locations. For example, a user may have the authorization to schedule resources at multiple locations. If the user can actively schedule resources at the locations requested, then the user from the current location may schedule a resource at another location. When the user does this, the schedule for the other location will reflect the scheduling and changes, if made, accordingly.

It will be readily apparent to those skilled in the art that the methods and systems disclosed herein could take other forms or embodiments without departing from the scope and spirit of the present invention. For example, the method and system disclosed herein could reside on several personal computers that are electronically connected together. In the alternative, remote monitors could be electronically connected to a server or several servers to achieve the same objectives as described herein.

Although this disclosure has been shown and described with respect to detailed embodiments, those skilled in the art will understand that various changes in form and detail may be made without departing form the scope of the claimed disclosure.

What is claimed is:

1. A method for scheduling resources from a workforce pool, comprising the steps of
updating human resource information regarding availability of each human resource;
forecasting human resource workload for a specified time period;
storing the human resource information and the forecasted human resource workload information into a central database;
accessing the central database to schedule non-pooled human resources;
determining understaffed time periods by comparing the forecasted human resource workload versus available resources from scheduling the non-pooled human resources; and
scheduling pooled human resources to cover the understaffed forecasted human resource workload.

2. A method of claim 1, wherein the forecasted human resource workload is determined upon historical information.

3. A method according to claim 1, wherein human resources are shared from one workload center to another.

4. A method of claim 1, wherein the step of updating human resource information includes human resource skill sets.

5. A method of claim 1, wherein the step of scheduling pooled human resources to cover the understaffed forecast is completed from a central scheduling location.

6. A method of claim 1, wherein the step of scheduling pooled human resources to cover the understaffed forecast includes accessing from a pool of available appropriately skilled resources located in a specific geographic region.

7. The system of claim 1, wherein the step of scheduling pooled human resources to cover the understaffed forecast includes analyzing human resource availability.

8. A method for scheduling resources from a workforce pool, comprising the steps of
updating human resource information regarding availability of each human resource;
forecasting human resource workload for a specified time period;
storing the human resource information and the forecasted human resource workload information into a central database;
determining understaffed time periods by comparing the forecasted human resource workload versus available resources; and
scheduling pooled human resources to cover the understaffed forecast.

9. A method of claim 8, wherein the forecasted human resource workload is determined upon historical information.

10. A method according to claim 8, wherein human resources are shared from one workload center to another.

11. A method of claim 8, wherein the step of updating human resource information includes human resource skill levels.

12. A method of claim 8, wherein the step of scheduling pooled human resources to cover the understaffed forecast is completed from a central scheduling location.

13. A method of claim 8, wherein the step of scheduling pooled human resources to cover the understaffed forecast includes accessing from a pool of available appropriately skilled resources located in a specific geographic region.

14. The system of claim 8, wherein the step of scheduling pooled human resources to cover the understaffed forecast includes analyzing human resource availability.

15. A system for scheduling a pool of human resources, comprising:
a central database for storing human resource information, including human resource availability and current scheduling information, the database being electronically connected to a network;
at least one remote work station connected to the database by the network, wherein the remote work station allows the viewing of forecasted workloads, and current staffing assigned to the forecasted workloads to determine periods of understaffing and overstaffing.

16. The system according to claim 15, further comprising:
a scheduling interface electronically connected to the central database for the scheduling of human resources based upon the forecasted workload.

17. The system according to claim 16, wherein the central database stores a skill set of each human resource so that the appropriate resource may be scheduled to appropriately staff the forecasted workload.

18. The system according to claim 17, wherein the database further stores geographic information relating to each human resource.
